(19) United States
(12) Patent Application Publication
(10) Pub. No.: US 2006/0221827 A1
(43) Pub. Date: Oct. 5, 2006

(54) TCP IMPLEMENTATION WITH MESSAGE-COUNT INTERFACE

(75) Inventors: Vadim Makhervaks, Yokneam (IL); Leah Shalev, Zichron-Yaakov (IL)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/907,506

(22) Filed: Apr. 4, 2005

(51) Int. Cl. H04L 12/26

(52) U.S. Cl. 370/230

(57) ABSTRACT

A method for implementing TCP (transmission control protocol), the method including updating a number of pending requests received for data transmission via a TCP connection, the number of pending requests being called the message count, and making a decision regarding data transmission based on the message count regardless of a byte count of data to be transmitted.

### FIELD OF THE INVENTION

The present invention relates generally to implementations of TCP (transmission control protocol), and particularly to an implementation of TCP in which data transmission is based on the message count instead of the byte count of the pending data.

### BACKGROUND OF THE INVENTION

Reference is made to FIG. 1, which illustrates a typical TCP implementation of the prior art. An application posts a request for data transmission by passing a command to the TCP to send data, for example, by means of a function call (step 101). The TCP reads the command, and updates the connection-specific control information to keep a record of the command (step 102). The connection-specific control information may include, without limitation, pointers to data buffers, byte count of outstanding data, and other information. Afterwards, the TCP may attempt to send more data on the connection, by examining the connection state, e.g., data amount, flow control and congestion control information, and other information (step 103). In most cases, the data cannot be transmitted right away because of protocol limitations. Normally the data is transmitted later, upon receipt of acknowledgements (ACKs) for previously transmitted data. When data transmission is allowed, the TCP uses the stored connection-specific control information to build a packet descriptor structure (including a TCP header), and passes the packet descriptor to a lower layer for transmission (step 104).

The transmission control protocol may be offloaded to an intelligent network adapter, such as a TOE—TCP/IP (Internet Protocol) Offload Engine, which may be implemented in software. In such a case, the TCP implementation may be as described above, except that instead of function calls, the TCP may interface with the upper layer using a queue of requests carrying information corresponding to each send call. TOE implementation may read each such request, and process it as a regular TCP implementation.

TCP may be implemented in software or hardware. As network transmission rates increase, straightforward TOE implementation in software may fail to provide the required performance. Hardware implementation has the potential to solve this problem, but it has other problems. For example, hardware implementation of TCP differs from software implementation in the way it interacts with the application and with the rest of the system. In particular, memory accesses to control information, either internal or provided by an application, impose a higher overhead.

### SUMMARY OF THE INVENTION

The proposed invention employs an implementation of TCP which does not use the length of data posted for transmission at the submission time. In one non-limiting embodiment, upon posting a request, the TCP implementation updates the number of pending requests for the corresponding connection, without reading the request itself, and without knowing the actual amount of pending data. The TCP keeps track of the number of remaining pending messages as it transmits data, and makes the decisions on data transmission based on the message count only, instead of the byte count of the pending data.

The present invention may be implemented in hardware and/or software. By not relying on the byte count, the memory accesses to the control information as well as overhead may be reduced, which may improve transmission speed and efficiency.

### BRIEF DESCRIPTION OF THE DRAWINGS

The present invention will be understood and appreciated more fully from the following detailed description taken in conjunction with the appended drawings in which:

FIG. 1 is a simplified block diagram illustration of a prior art TCP implementation;

FIG. 2 is a simplified block diagram illustration of a TCP implementation, in accordance with an embodiment of the invention; and

FIGS. 3A-3B together form a simplified flow chart of a TCP implementation, in accordance with an embodiment of the invention.

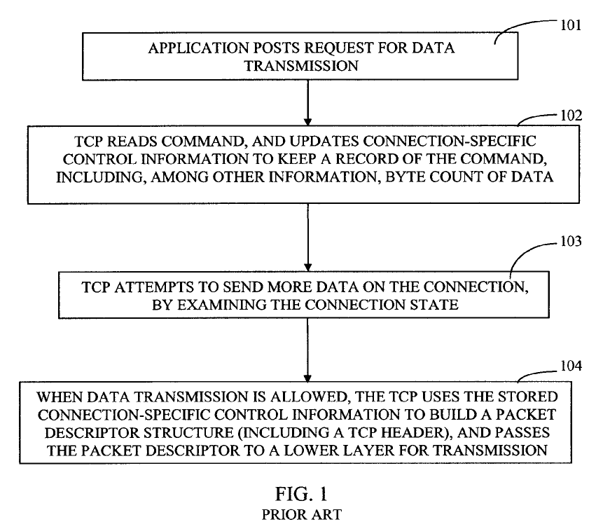

### DETAILED DESCRIPTION OF THE EMBODIMENTS

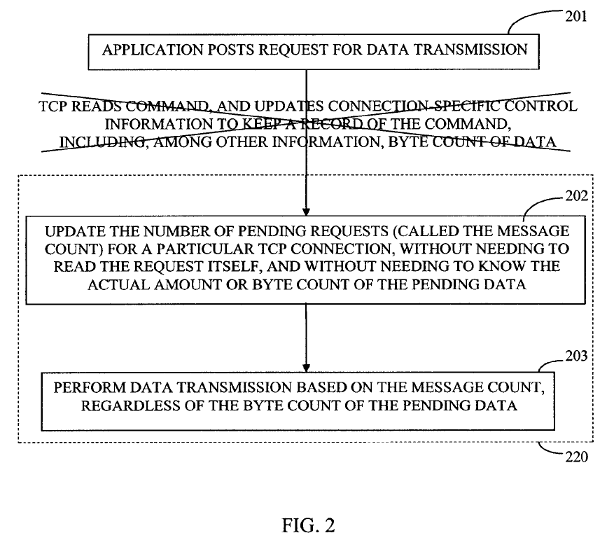

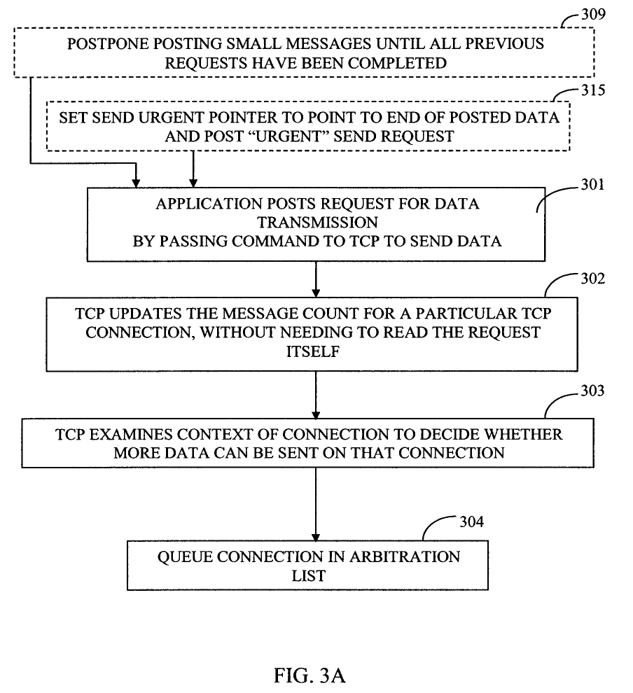

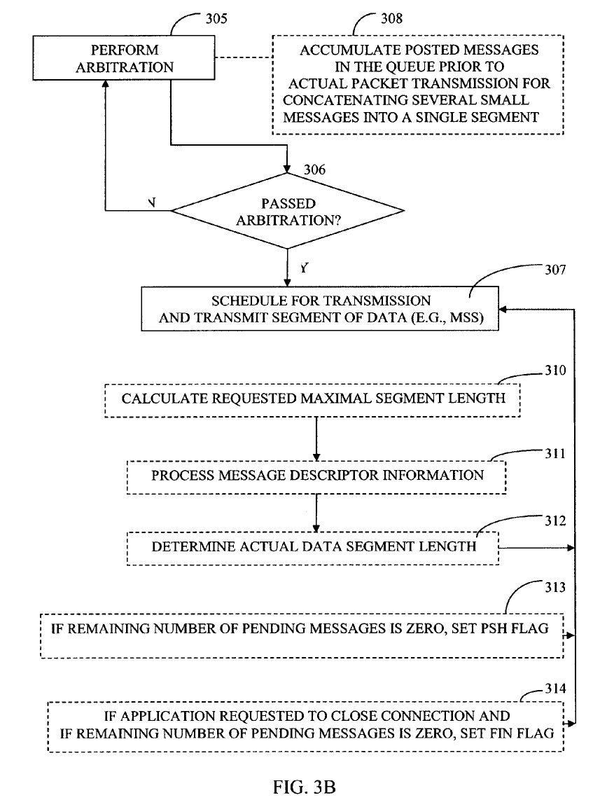

Reference is now made to FIG. 2, which briefly illustrates a TCP implementation in accordance with an embodiment of the present invention. A more detailed description is given below with reference to FIGS. 3A-3B.

Briefly, an application may post a request for data transmission (step 201). In contrast with the prior art, which must read the command, update the connection-specific control information, and then examine the connection state to obtain the byte count for transmitting the data, in the present invention, the TCP implementation may update the number of pending requests (called the message count) for a particular TCP connection, without needing to read the request itself, and without needing to know the actual amount or byte count of the pending data (step 202). The TCP may keep track of the number of remaining pending messages as it transmits data, and may perform data transmission (e.g., make decisions regarding data transmission) based on the message count, regardless of the byte count of the pending data (step 203).

Reference is now made to FIGS. 3A-3B, which are a flow chart of a TCP implementation in accordance with an embodiment of the present invention. It is noted that in TCP, application requests may be handled in parallel and independently of TCP transmission.

An application may post a request for data transmission by passing a command to the TCP to send data (step 301), such as but not limited to, by means of a function call or doorbell mechanism (mentioned below). A separate request queue may be used for each connection. In this manner, requests from one connection will not interfere with or block requests from another connection. Upon posting a request, the TCP implementation may update the number of pending requests for that particular connection, without reading the request itself (step 302). Contrary to the prior art, the TCP implementation (or the TCP, for short) of the present invention does not “know” the actual amount of pending data or byte count and does not need to take it into account. Rather, as is now described, the TCP keeps track of the number of remaining pending messages as it transmits data, and decisions regarding data transmission are based on the message count and not the byte count of data.

After updating the number of pending requests for a particular connection, data can be sent on that connection. The trigger for transmitting data on the connection may be, without limitation, a data post request or an acknowledgement (ACK) of previously sent data. In any event, before transmitting data, the TCP may examine the context of the particular connection to decide whether more data can be sent on that connection (step 303). If the connection is ready for data transmission, it is queued in an arbitration list (step 304).

Reference is now made particularly to FIG. 3B. TCP transmission may be invoked by an arbiter (e.g., after a data post or ACK arrival), which performs arbitration (step 305). If the preceding connections have been served and a particular connection passes arbitration (step 306), then that particular selected connection is scheduled and ready for transmission. As long as the pending message count is non-zero, a segment of data may be transmitted (step 307).

Data transmitter logic serves the connection scheduled by the arbiter (e.g., reads requests and generates segments). As is well known in the art of TCP implementation, the TCP typically breaks the incoming application byte stream into segments. A segment is the unit of end-to-end transmission. A segment consists of a TCP header followed by application data. The Maximum Segment Size (MSS) is defined as the largest quantity of data that can be transmitted at one segment. Accordingly, in step 307, the MSS of the particular connection may be transmitted, e.g., in accordance with flow and congestion control algorithms (known and used in the art). After data transmission, the process may start over again when another request for data transmission is posted (step 301, above).

As mentioned above, the prior art bases decisions regarding data transmission on the byte count. As a result, there are prior art TCP implementations that require knowing the byte count. Although the TCP implementation in the present invention does not utilize the byte count, nevertheless the invention has other provisions for providing those TCP implementations, as is now explained.

One well known algorithm that may be used in TCP implementations is the Nagle algorithm. The Nagle algorithm (“nagling”) is used to automatically concatenate a number of small buffer messages. Nagling may increase the efficiency of the system by decreasing the number of packets that must be sent. However, nagling normally requires knowledge of the byte count.

In accordance with a non-limiting embodiment of the present invention, the particular connection may not be immediately processed upon receiving a data post request. Instead, posted messages (i.e., the pending requests) may be accumulated in the queue prior to actual packet transmission (and prior to or during arbitration) (step 308). This accumulation is likely to occur automatically during the time that arbitration is carried out. This may improve the chances to concatenate several small messages into a single segment, without checking the amount of outstanding data, i.e., without checking the byte count. Alternatively or additionally, it is possible to implement the Nagle algorithm by means of a software layer of the host interface for the TCP engine. The software can postpone posting small messages until all previous requests have been completed (step 309).

Some TCP implementations require making decisions based on the segment length of the data, which the present invention does not “know” (and does not need to know) because the segment length is correlated to the available byte count. In accordance with a non-limiting embodiment of the present invention, such decisions may be made by first calculating the requested maximal segment length, such as in accordance with the connection sender MSS and option size (step 310). Afterwards, message descriptor information may be processed (step 311), and the actual data segment length may be determined (step 312).

In prior art TCP implementations, a push (PSH) flag may be set in the TCP header when transmitting the last available portion of data. In the present invention, the decision to set the PSH flag may be made after processing the message descriptor information (step 311, above). If the remaining number of pending messages is 0, then the PSH flag may be set (step 313).

Some prior art TCP implementations employ a FIN (finish) flag, which is a TCP control bit that occupies one sequence number, and indicates that the sender has finished sending data. In the prior art TCP implementations, the FIN flag must be set in the TCP header when transmitting the last available portion of data, if the application has requested to close the connection. In the present invention, the decision to set the FIN flag may be made after processing the message descriptor information (step 311, above). If the remaining number of pending messages is 0, then the FIN flag may be set (step 314).

Prior art TCP implementations may have an urgent mode for processing and transmitting urgent send requests. In the prior art, when the TCP receives an urgent send call, a context field or TCP sequence number, called the Send Urgent Pointer (SND.UP), is set to point to the end of the posted data, and used later when building TCP headers for all data preceding the urgent pointer. In the present invention, the software of the host interface layer may set the Send Urgent Pointer to point to the end of the posted data, prior to posting the “urgent” send request (step 315). The software of the host interface layer is responsible for maintaining the counter of posted data bytes, which is readily available from application calls.

The present invention may be carried out wherein the TCP connection state is implemented as RDMA (Remote Direct Memory Access) over TCP, in which RDMA and TCP processing is integrated. For example, a Remote Network Interface Controller (RNIC) may be provided to support the functionality of RDMA over TCP, and can include a combination of TCP offload and RDMA functions in the same network adapter. In an implementation of RDMA over TCP, the TCP does not use intermediate data structures, and the full processing of an RDMA request may be postponed until the TCP connection state allows actual packet (data) transmission (steps 304-307 above). In other words, send requests may be kept in data structures in the host memory, written by the host software and read by the TCP implementation on the adapter, after a decision on packet transmission is made, just before the packet transmission (and the TCP byte count is not known until then). This is different form the prior art, wherein an adapter reads each request, processes it and generates locally corresponding data structures (which basically contain the same information in a different form), which should be read again later, when actual packet transmission becomes possible.

In an implementation of RDMA over TCP, the TCP may be notified of the request posting through a doorbell mechanism (step 301, above). However, the amount of control information that can be passed through the doorbell mechanism is limited, since all information is passed by writing a single word to the doorbell address. In particular, the data length is not passed through the doorbell mechanism, but is provided as a part of RDMA message descriptor memory structure. This is completely suitable and adequate for the present invention, because, as described above, the method of the invention does not need to “know” the data length. Rather, the message descriptor information may be processed (as in step 311 above), and the actual data segment length may be determined (as in step 312 above).

Accordingly, the methods described hereinabove may be carried out by hardware or in software by a computer program product, such as but not limited to, software in a network adapter 220 (shown in FIG. 2), e.g., the RNIC or other suitable controller or adapter, which may include instructions for carrying out any one or all of the processes described hereinabove.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for implementing TCP (transmission control protocol), the method comprising:
updating a number of pending requests received for data transmission via a TCP connection, the number of pending requests being called the message count; and
making a decision regarding data transmission based on the message count regardless of a byte count of data to be transmitted.

2. The method according to claim 1, further comprising posting a plurality of requests for data transmission via a separate request queue for each connection.

3. The method according to claim 1, further comprising transmitting a segment of data having a Maximum Segment Size (MSS).

4. The method according to claim 1, further comprising accumulating the pending requests in a queue prior to actual transmission, and concatenating small messages into a single segment.

5. The method according to claim 1, further comprising postponing posting requests of small size until all previous requests have been completed.

6. The method according to claim 1, further comprising calculating a requested maximal segment length of data to be transmitted, and processing message descriptor information contained in the data to determine actual data segment length.

7. The method according to claim 1, further comprising processing message descriptor information contained in the data to be transmitted, and if the message count is zero, setting a push (PSH) flag in a TCP header of the data transmission.

8. The method according to claim 1, further comprising processing message descriptor information contained in the data to be transmitted, and if the message count is zero and a request to close connection has been received, setting a finish (FIN) flag in a TCP header of the data transmission.

9. The method according to claim 1, further comprising, prior to updating the message count, setting a send urgent context field in the data to be transmitted.

10. The method according to claim 1, further comprising keeping send requests in data structures in a host memory prior to data transmission.

11. A computer program product for implementing TCP, the computer program product comprising:
first instructions for updating a number of pending requests received for data transmission via a TCP connection, the number of pending requests being called the message count; and
second instructions for making a decision regarding data transmission based on the message count regardless of a byte count of data to be transmitted.

12. The computer program product according to claim 11, further comprising instructions for accumulating the pending requests in a queue prior to actual transmission, and concatenating small messages into a single segment.

13. The computer program product according to claim 11, further comprising instructions for postponing posting requests of small size until all previous requests have been completed.

14. The computer program product according to claim 11, further comprising instructions for calculating a requested maximal segment length of data to be transmitted, and instructions for processing message descriptor information contained in the data to determine actual data segment length.

15. The computer program product according to claim 11, further comprising instructions for processing message descriptor information contained in the data to be transmitted, and if the message count is zero, instructions for setting at least one of a PSH flag and a FIN flag in a TCP header of the data transmission.

16. A system for implementing TCP, the system comprising:
a TCP connection state adapted to update a number of pending requests received for data transmission, the number of pending requests being called the message count, and to make a decision regarding data transmission based on the message count regardless of a byte count of data to be transmitted; and
an arbiter in communication with the TCP connection state, adapted to perform arbitration for TCP transmission.

17. The system according to claim 16, comprising a separate request queue for each TCP connection for which a request for data transmission is received.

18. The system according to claim 16, wherein said TCP connection state is adapted to accumulate the pending requests in a queue prior to actual transmission, and to concatenate small messages into a single segment.

19. The system according to claim 16, wherein said TCP connection state is adapted to calculate a requested maximal segment length of data to be transmitted, and to process message descriptor information contained in the data to determine actual data segment length.

20. The system according to claim 16, wherein said TCP connection state is adapted to process message descriptor information contained in the data to be transmitted, and if the message count is zero, to set at least one of a PSH flag and a FIN flag in a TCP header of the data transmission.
